(19) United States
(12) Patent Application Publication
(10) Pub. No.: US 2026/0249502 A1
(43) Pub. Date: Aug. 27, 2026

(54) CONTROLLER AND CONTROL METHOD

(71) Applicant: HONDA MOTOR CO., LTD., TOKYO (JP)

(72) Inventors: Yusuke WADA, WAKO-SHI (JP); Kensuke NAMBA, WAKO-SHI (JP); Masami KURIMOTO, WAKO-SHI (JP); Masahiro SHIWA, WAKO-SHI (JP)

(21) Appl. No.: 19/540,917

(22) Filed: Feb. 16, 2026

(30) Foreign Application Priority Data
Feb. 25, 2025 (JP) 2025-027716

(51) Int. Cl. B26D 5/16; B26D 5/02; B26D 5/32; B26D 7/01; B26D 7/24; G03G 15/00

(52) U.S. Cl. CPC B26D 5/16; B26D 5/02; B26D 5/32; B26D 7/015; B26D 7/24; G03G 15/6582; B65H 2301/331

(57) ABSTRACT

A controller for a punching device configured to sequentially punch a sheet base material into a predetermined shape while feeding the sheet base material in the longitudinal direction acquires image information on the sheet base material from an imaging device, determines, based on the image information, whether there is a specific reserved-for-punching area, which is a reserved-for-punching area that overlaps a defective site included in the sheet base material, and shifts the reserved-for-punching area determined to be the specific reserved-for-punching area to the upstream side of the feeding path for the sheet base material with respect to the defective site if there is the specific reserved-for-punching area.

### CROSS-REFERENCE TO RELATED APPLICATIONS

This application is based upon and claims the benefit of priority from Japanese Patent Application No. 2025-027716 filed on Feb. 25, 2025, the contents of which are incorporated herein by reference.

### BACKGROUND OF THE INVENTION

### Field of the Invention

The present disclosure relates to a controller and a control method.

### Description of the Related Art

JP 2016-225059 A discloses an inspection device for inspecting coating defects of electrodes of fuel cells. According to the disclosure, the inspection device determines whether a coating defect is good or bad based on an image acquired with a camera.

### SUMMARY OF THE INVENTION

Recently, a better technology is desired for a punching device that sequentially punches a long sheet base material into a predetermined shape.

The present disclosure aims to solve the aforementioned problems.

The first aspect of the present disclosure is a controller for a punching device configured to sequentially punch a long sheet base material into a predetermined shape while feeding the sheet base material in the longitudinal direction of the sheet base material, wherein a plurality of reserved-for-punching areas that are to be punched by the punching device are set in advance on the sheet base material so as to be arranged in the longitudinal direction at predetermined intervals, the controller comprising: an image information acquisition unit configured to acquire image information on the sheet base material from an imaging device configured to image the sheet base material; a determination unit configured to determine, based on the image information, whether a specific reserved-for-punching area is present, which is a reserved-for-punching area that overlaps at least one defective site included in the sheet base material; and an area resetting unit configured to shift, in a case where the specific reserved-for-punching area is present, the reserved-for-punching area determined to be the specific reserved-for-punching area upstream in the feed path for the sheet base material with respect to the defective site.

The second aspect of the present disclosure is a method for controlling a punching device configured to sequentially punch a long sheet base material into a predetermined shape while feeding the sheet base material in the longitudinal direction of the sheet base material, wherein a plurality of reserved-for-punching areas that are to be punched by the punching device are set in advance on the sheet base material so as to be arranged in the longitudinal direction at predetermined intervals, the method comprising: an image information acquisition step of acquiring image information on the sheet base material from an imaging device configured to image the sheet base material; a determination step of determining, based on the image information, whether a specific reserved-for-punching area is present, which is a reserved-for-punching area that overlaps at least one defective site included in the sheet base material; and an area resetting step of shifting, in a case where the specific reserved-for-punching area is present, the reserved-for-punching area determined to be the specific reserved-for-punching area upstream in the feed path for the sheet base material with respect to the defective site.

According to the present disclosure, a controller and a control method are provided that can produce a good-quality product that does not contain defective sites while reducing the unused area of a sheet base material.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a configuration diagram of a punching system according to an embodiment;

FIG. 2A is a schematic diagram showing a plurality of reserved-for-punching areas that is determined beforehand on a sheet base material; FIG. 2B is a schematic diagram showing a plurality of reserved-for-punching areas after an area resetting process is performed;

FIG. 3A is a diagram showing an example of a mark applied to the sheet base material; FIG. 3B is a diagram showing another example of a mark applied to the sheet base material;

FIG. 4 is a flow chart of a control method according to one embodiment;

FIG. 5 is a configuration diagram of a punching system according to a first modified example; and

FIG. 6 is a configuration diagram of a punching system according to a second modified example.

### DETAILED DESCRIPTION OF THE INVENTION

The problem described below is raised regarding a punching device that sequentially punches a long sheet base material into a predetermined shape while the sheet base material is fed in a predetermined longitudinal direction. As proposed in JP 2016-225059 A mentioned above, it is conceivable to determine defective sites of the sheet base material based on image information. However, when a defective site is detected, it is necessary to appropriately set an area to be punched by the punching device so that the defective site is not included in the area. In this case, it is not preferable that an unused area (waste area) of the sheet base material that is not punched by the punching device increase. A technology that improves material utilization while ensuring quality is desired.

In light of the above preliminary description, embodiments are described below. Note that a program (computer program, computer software) in the following description is also referred to as a computer program product. Computer program products are not limited to programs stored on storage media (recording media), but also include programs that are transmitted, distributed, or downloaded via networks such as the Internet.

### Embodiments

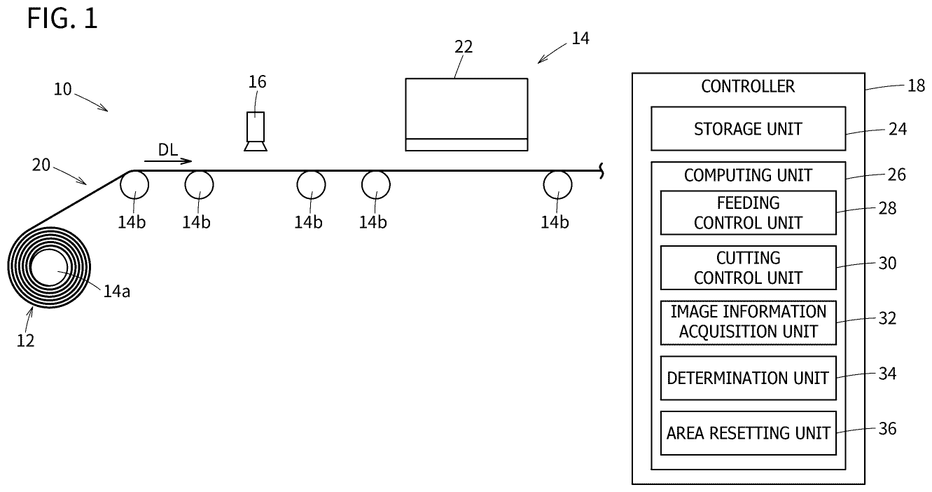

FIG. 1 is a configuration diagram of a punching system 10 according to an embodiment.

The punching system 10 is a system for sequentially punching a long sheet base material 12 into a predetermined shape while feeding the sheet base material 12 in the longitudinal direction DL. The sheet base material 12 is, for example, a carbon paper on which electrodes are formed, the carbon paper being provided in a fuel cell or the like. The direction of the feeding of the sheet base material 12 by punching system 10 is aligned with the longitudinal direction DL of the sheet base material 12. As shown in FIG. 1, the punching system 10 includes a punching device 14, an imaging device 16, and a controller 18.

The punching device 14 includes a feeding machine 20 and a cutter 22.

The feeding machine 20 is a machine that feeds the sheet base material 12 in the longitudinal direction DL. For example, the feeding machine 20 includes a bobbin 14a and a plurality of rollers 14b. The bobbin 14a and the plurality of rollers 14b are arranged along the feeding direction of the sheet base material 12. The sheet base material 12 is wound around the bobbin 14a. Each of the rollers 14b is rotated by, for example, a motor (not shown). The rollers 14b are rotated to feed the sheet base material 12 from the bobbin 14a in the feeding direction (longitudinal direction DL). A motor (not shown) may be further provided to rotate the bobbin 14a.

The cutter 22 is a machine that punches the sheet base material 12 into the predetermined shape. For example, a press equipped with a cutter is included in the cutter 22. The cutter 22 is placed on a feeding path for the sheet base material 12 fed by the feeding machine 20. The sheet base material 12 is sequentially punched into the predetermined shape by the cutter 22 while being fed in the longitudinal direction DL by the feeding machine 20.

The imaging device 16 is a device that images the sheet base material 12. For example, a camera is included in the imaging device 16. The position of the imaging device 16 in the feeding path for the sheet base material 12 is upstream of the position of the cutter 22 in the feeding path.

The controller 18 is an electronic device (computer) that controls the punching device 14. The controller 18 includes a storage unit 24 and a computing unit 26.

The storage unit 24 includes one or more memories. The storage unit 24 includes a non-volatile memory such as a ROM (Read Only Memory), a flash memory, a magnetic disk, and the like. The non-volatile memory is a storage medium that stores programs, tables, maps, and so on in a non-transitory manner. At least part of the storage unit 24 may be realized by a storage medium such as a USB (Universal Serial Bus) memory, a memory card, or an optical disk. The storage unit 24 may include a volatile memory such as a RAM (Random Access Memory).

The computing unit 26 includes processing circuitry capable of executing computation processing. This processing circuitry may have one or more processors. For example, the processing circuitry may include a CPU (Central Processing Unit), a GPU (Graphics Processing Unit), and the like. The processing circuitry may include an IC (Integrated Circuit) or a discrete device.

The computing unit 26 includes a feeding control unit 28, a cutting control unit 30, an image information acquisition unit 32, a determination unit 34, and an area resetting unit 36. The feeding control unit 28, the cutting control unit 30, the image information acquisition unit 32, the determination unit 34, and the area resetting unit 36 are realized by the above-described processing circuitry. For example, programs stored in the storage unit 24 are executed by the processor of the computing unit 26, whereby the feeding control unit 28, the cutting control unit 30, the image information acquisition unit 32, the determination unit 34, and the area resetting unit 36 are realized. At least one of the IC and the discrete device described above may realize at least part of the feeding control unit 28, the cutting control unit 30, the image information acquisition unit 32, the determination unit 34, and the area resetting unit 36.

The feeding control unit 28 controls the feeding machine 20 to feed the sheet base material 12 in the feeding direction (longitudinal direction DL). For example, the feeding control unit 28 controls the feeding speed of the sheet base material 12 by controlling the motors that rotate the bobbin 14a and the rollers 14b.

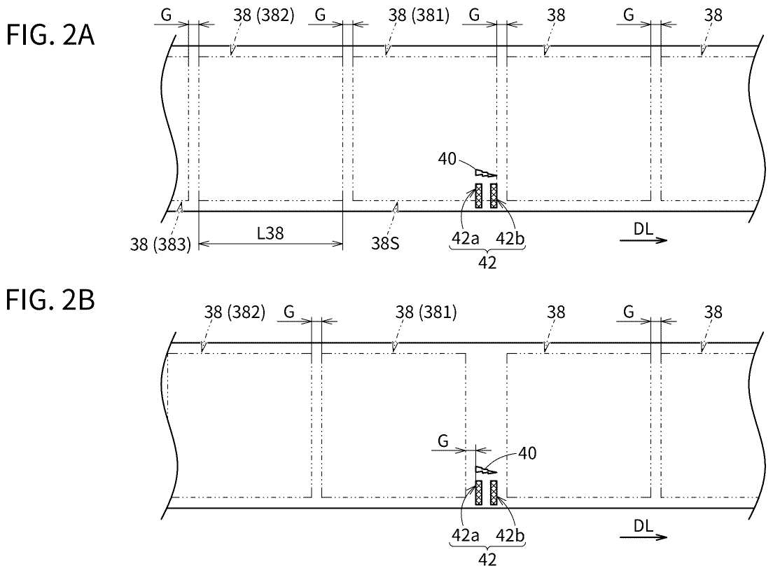

FIG. 2A is a schematic diagram showing a plurality of reserved-for-punching areas 38 that is determined beforehand on the sheet base material 12.

The feeding control unit 28 may control the feeding machine 20 based on a predetermined interval G of the reserved-for-punching areas 38 determined in advance on the sheet base material 12. Each of the reserved-for-punching areas 38 is an area punched by the punching device 14 (the cutter 22). The reserved-for-punching areas 38 are arranged in the longitudinal direction DL of the sheet base material 12 at the predetermined intervals G. The feeding control unit 28 may temporarily stop the feeding of the sheet base material 12 each time the reserved-for-punching area 38 reaches a position where the sheet base material 12 can be punched by the cutter 22. In other words, the feeding control unit 28 may control the feeding machine 20 to temporarily stop the feeding of the sheet base material 12 each time a feeding amount of the sheet base material 12 reaches the predetermined interval G described above after one of the reserved-for-punching areas 38 is punched. In this case, the feeding control unit 28 can specify the feeding amount (movement amount) of the sheet base material 12 based on, for example, a signal indicating a rotational position of the roller 14b (motor) described above. For example, the signal is output from a rotational position sensor such as an encoder provided at the roller 14b (motor).

The predetermined interval G is preferably set shorter than a dimension L38 in the longitudinal direction DL of each of the reserved-for-punching areas 38 (G<L38). This suppresses an increase in unused areas on the sheet base material 12.

The cutting control unit 30 controls the cutter 22 to sequentially punch into the predetermined shape the sheet base material 12 being fed in the longitudinal direction DL. As described above, the feeding of the sheet base material 12 may be temporarily stopped each time the reserved-for-punching area 38 reaches a position where the sheet base material 12 can be punched by the cutter 22. In that case, the cutting control unit 30 can control the cutter 22 to punch the reserved-for-punching areas 38 while the feeding of the sheet base material 12 is temporarily stopped.

The image information acquisition unit 32 acquires image information of the sheet base material 12 from the imaging device 16.

The determination unit 34 performs presence/absence determination based on a detection signal of the rotational position sensor described above, a position of the imaging device 16 in the feeding path, and the image information acquired by the image information acquisition unit 32. The presence/absence determination includes a process of determining whether a specific reserved-for-punching area 38S is present on the sheet base material 12. The specific reserved-for-punching area 38S is a reserved-for-punching area 38 that overlaps a defective site 40 included in the sheet base material 12. The defective site 40 is, for example, a site where the application of the above-mentioned electrodes is defective, a site where flaws have been formed, or the like.

For this presence/absence determination, a mark 42 indicating the position of the defective site 40 is attached beforehand to the sheet base material 12 before the imaging by the imaging device 16. The mark 42 is applied beforehand to the sheet base material 12 using, for example, a paint such as ink. The determination unit 34 determines whether the specific reserved-for-punching area 38S is present on the sheet base material 12, based on the position of the mark 42 indicated by the image information. The determination unit 34 can identify (estimate) the position of the reserved-for-punching area 38 indicated by the image information, based on, for example, the detection signal of the rotational position sensor provided at the roller 14b (motor) and the position of the imaging device 16 on the feeding path for the sheet base material 12. The determination unit 34 can execute the presence/absence determination by matching the position of the identified reserved-for-punching area 38 with the position of the defective site 40 (mark 42).

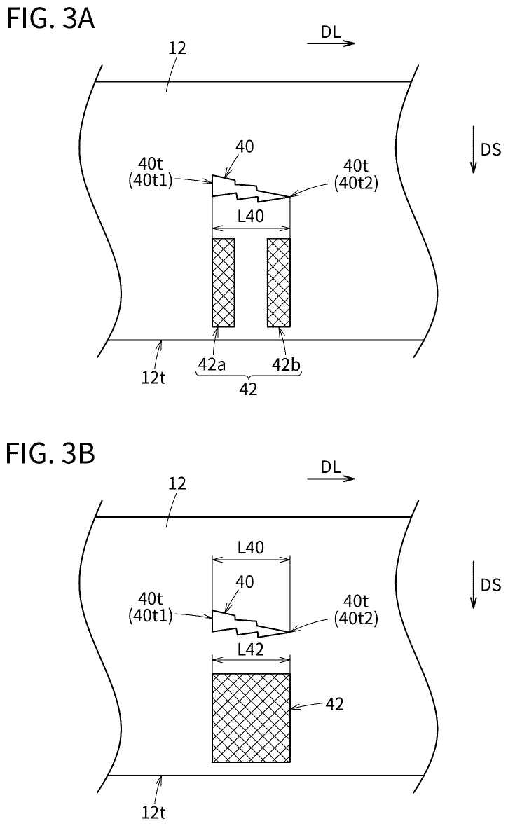

FIG. 3A is a diagram showing an example of the mark 42 applied to the sheet base material 12. FIG. 3B is a diagram showing another example of the mark 42 applied to the sheet base material 12.

The mark 42 indicating the position of the defective site 40 is preferably applied to a predetermined site of the sheet base material 12. In that case, the mark 42 may be applied to an end portion 12t of the sheet base material 12 in the transverse direction DS of the sheet base material 12.

When a placement site of the mark 42 on the sheet base material 12 is determined in advance, it is sufficient that the imaging range imaged by the imaging device 16 includes the placement site. Therefore, it is not necessary to image, for example, a relatively wide imaging range to find the defective site 40 that is present somewhere on the sheet base material 12. Further, it is not necessary to increase the number of imaging devices 16 to cover a relatively wide imaging range.

Moreover, it is preferable that the mark 42 indicating the position of the defective site 40 have a predetermined pattern (color, design, etc.). In that case, for example, as shown in FIG. 3A, the mark 42 may have a first partial pattern 42a and a second partial pattern 42b indicating end positions 40t (40t1, 40t2) of the defective site 40 in the longitudinal direction DL of the sheet base material 12. The first partial pattern 42a of FIG. 3A shows the first end position 40t1 the defective site 40 in the longitudinal direction DL. The second partial pattern 42b of FIG. 3A shows the second end position 40t2 of the defective site 40 in the longitudinal direction DL. Also, as shown in FIG. 3B, a dimension L42 of the mark 42 in the longitudinal direction DL may be determined according to the dimension L40 of the defective site 40 in the longitudinal direction DL of the sheet base material 12.

If the pattern of the mark 42 is predetermined, it is easy to detect the mark 42 based on the image information. Therefore, when the mark 42 has a predetermined pattern, the determination unit 34 can well specify the position of the defective site 40 based on the image information. The amount of paint consumed when the mark 42 in FIG. 3B is formed varies depending on the dimension L40 of the defective site 40 that corresponds to the mark 42. On the other hand, the shape and dimension of each of the partial patterns (42a, 42b) indicating the positions of both ends of the defective site 40 may be constant regardless of the dimension L40 of the defective site 40. In light of this, the mark 42 of FIG. 3A is preferable to the mark 42 of FIG. 3B from the perspective of reducing the paint consumption.

The area resetting unit 36 executes an area resetting process when the specific reserved-for-punching area 38S is determined to be present through the presence/absence determination. The area resetting process includes a first resetting process and a second resetting process.

FIG. 2B is a schematic diagram showing a plurality of reserved-for-punching areas 38 after the area resetting process is performed on the sheet base material 12 of FIG. 2A.

The first resetting process is a process of shifting the reserved-for-punching area 38 determined to be the specific reserved-for-punching areas 38S through the presence/absence determination to the upstream side in the longitudinal direction DL with respect to the defective site 40. Thus, the position on the feeding path for the reserved-for-punching area 38 determined to be the specific reserved-for-punching area 38S through the presence/absence determination is reset to the upstream side of the position of the defective site 40 on the feeding path. As a result, the incorporation of the defective site 40 into a product made from the sheet base material 12 using the punching system 10 is prevented.

For example, in the example of FIG. 2A, a reserved-for-punching area 381 corresponds to the specific reserved-for-punching area 38S. In this case, the area resetting unit 36 shifts the reserved-for-punching area 381 to the upstream side of the defective site 40 by performing the first resetting process (see FIG. 2B).

When the reserved-for-punching area 38 determined to be the specific reserved-for-punching area 38S is shifted upstream in the longitudinal direction DL with respect to the defective site 40, the area resetting unit 36 may reset the reserved-for-punching area 38 to a position separated from the defective site 40 by the predetermined interval G described above.

As a result of the position of the reserved-for-punching area 38 being reset by the first reset process, the reserved-for-punching area 38 could again overlap the defective site 40. For example, there could be a plurality of defective sites 40 on the sheet base material 12, including a first defective site and a second defective site. The position of the second defective site in the longitudinal direction DL of the sheet base material 12 is upstream of the position of the first defective site in the longitudinal direction DL.

In this case, the reserved-for-punching area 38 that has been shifted upstream through the first resetting process to avoid the first defective site could overlap the second defective site. In this case, the area resetting unit 36 executes the first resetting process again on a reserved-for-punching area 38 overlapping the second defective site and resets the reserved-for-punching area 38 to the upstream side with respect to the second defective site. For example, if the reserved-for-punching area 381 shown in FIG. 2B overlaps the defective site 40, the area resetting unit 36 shifts the reserved-for-punching area 381 further upstream from the position shown in FIG. 2B. In this way, the area resetting unit 36 may repeatedly execute the first resetting process until the reserved-for-punching area 38 determined to be the specific reserved-for-punching area 38S no longer overlaps the defective site 40.

The second resetting process is a process of shifting, according to the amount of upstream shifting of a reserved-for-punching area 38 determined to be the specific reserved-for-punching area 38S, all the reserved-for-punching areas 38 located upstream of the reserved-for-punching area 38. This prevents the position of a reserved-for-punching area 38 determined to be the specific reserved-for-punching area 38S from overlapping the positions of other reserved-for-punching areas 38 (382, 383) located upstream of the reserved-for-punching area 38.

When the area resetting process is executed, the cutting control unit 30 controls the cutter 22 to punch out the reserved-for-punching areas 38 having undergone the area resetting process. Thereby, the cutter 22 punches the sheet base material 12 avoiding the defective site 40. In this case, the cutting control unit 30 may specify (estimate), based on the detection signal of the rotational position sensor provided at the roller 14b (motor), the relative positional relationship between the cutter 22 and the reserved-for-punching areas 38 in the feeding path for the sheet base material 12. When the relative positional relationship between the cutter 22 and the reserved-for-punching areas 38 is in a state where the reserved-for-punching areas 38 can be punched out by the cutter 22, the cutting control unit 30 controls the cutter 22 to punch out the reserved-for-punching areas 38.

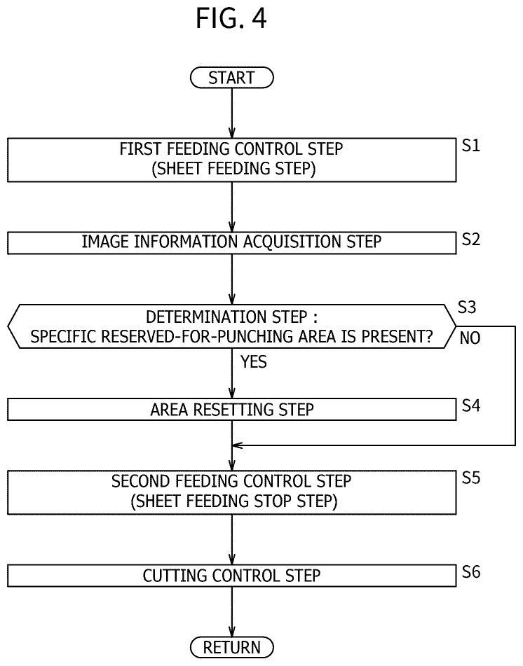

FIG. 4 is a flow chart of a control method according to one embodiment.

The controller 18 (computer) is capable of executing the control method shown in FIG. 4. For example, one or more processors included in the controller 18 execute programs stored in the memory, thereby causing the controller 18 to execute the control method of FIG. 4. The control method includes a first feeding control step (sheet feeding step) S1, an image information acquisition step S2, a determination step S3, an area resetting step S4, a second feeding control step (sheet feeding stop step) S5, and a cutting control step S6.

In the first feeding control step S1, the feeding control unit 28 controls the feeding machine 20 to feed the sheet base material 12 in the longitudinal direction DL of the sheet base material 12. In image information acquisition step S2, the image information acquisition unit 32 acquires image information from the imaging device 16.

In the determination step S3, the determination unit 34 performs the presence/absence determination. If it is determined that the specific reserved-for-punching area 38S is present, the area resetting step S4 is executed. If the specific reserved-for-punching area 38S is not present, the second feeding control step S5 is executed.

In the area resetting step S4, the area resetting unit 36 executes the area resetting process. Upon completion of the area resetting step S4, the second feeding control step S5 is executed.

In the second feeding control step S5, the feeding control unit 28 controls the feeding machine 20 to stop the reserved-for-punching area 38 at a position where the punching can be performed by the cutter 22. In the cutting control step S6, the cutting control unit 30 controls the cutter 22 to punch out the reserved-for-punching area 38. This concludes the sequence of the control methods of FIG. 4. Thereafter, the control method of FIG. 4 is repeatedly executed until all the reserved-for-punching areas 38 defined on the sheet base material 12 are punched out, for example.

According to the present embodiment, when the specific reserved-for-punching area 38S, which is a reserved-for-punching area 38 overlapping with the defective site 40, is not detected, the controller 18 sequentially punches multiple reserved-for-punching areas 38 arranged at the predetermined intervals G with the punching device 14. When a specific reserved-for-punching area 38S is detected, the controller 18 can reset multiple reserved-for-punching areas 38 so that they do not overlap the defective site 40. This allows the punching system 10 to produce good quality products that are free of the defect sites 40 while reducing the unused area of the sheet base material 12.

The present embodiment may be modified as described below. The description overlapping the embodiment will be omitted as appropriate. In addition, the reference numerals assigned to the elements in this embodiment are used in the following description unless otherwise specified.

### Modified Example 1

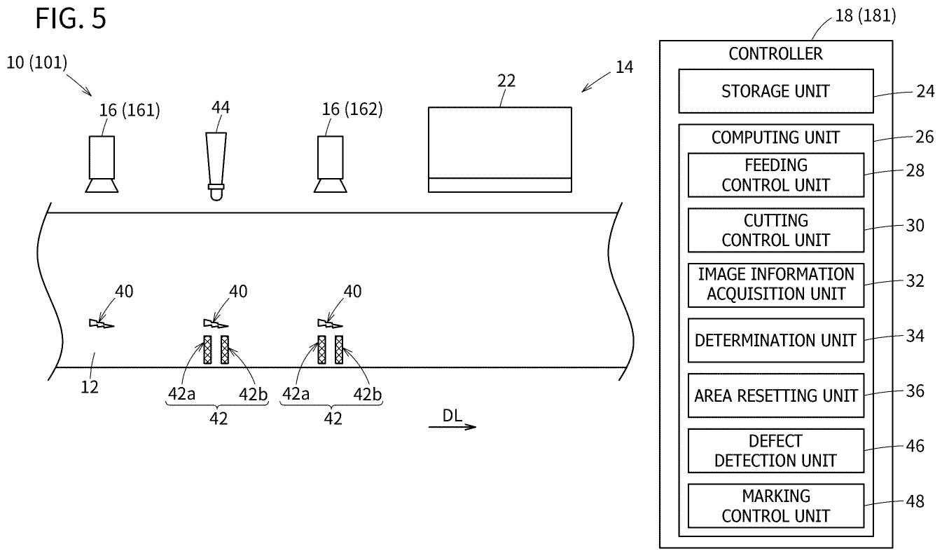

FIG. 5 is a configuration diagram of a punching system 10 (punching system 101) according to the first modified example.

The punching system 101 described below can apply to the sheet base material 12 the mark 42 that indicates the position of the defect site 40. The punching system 101 includes the punching device 14, a plurality of imaging devices 16, a marking device 44, and a controller 18 (controller 181) according to this modified example.

The plurality of imaging devices 16 are arranged upstream of the punching device 14. At least two imaging devices 16 among the plurality of imaging devices 16 are arranged along the feeding path for the sheet base material 12. The marking device 44 is placed between two imaging devices 16.

The imaging device 16 located upstream of the marking device 44 is also referred to as the first imaging device 161 for convenience in the following. On the other hand, the imaging device 16 located downstream of the marking device 44 is also referred to as the second imaging device 162 for convenience in the following.

The marking device 44 is a device for applying the mark 42 indicating the position of the defective site 40 to the sheet base material 12. For example, the marking device 44 includes a paint spray valve capable of spraying paint. The marking device 44 applies the mark 42 to the sheet base material 12 by spraying paint from the paint spray valve.

The controller 181 at least differs from the controller 18 of one embodiment in that it further includes a defect detection unit 46 and a marking control unit 48. The defect detection unit 46 and the marking control unit 48 are realized by the processing circuitry of the computing unit 26, as in the case of the feeding control unit 28 and the like.

The defect detection unit 46 detects the defective site 40 included in the sheet base material 12, based on the image information acquired from the first imaging device 161 by the image information acquisition unit 32. The marking control unit 48 controls the marking device 44 to apply to the sheet base material 12 the mark 42, which indicates the position of the defective site 40 detected by the defect detection unit 46. Thus, the sheet base material 12 with the mark 42 is imaged by the second imaging device 162. The determination unit 34 can perform the presence/absence determination based on image information acquired from the second imaging device 162 by the image information acquisition unit 32.

### Modified Example 2

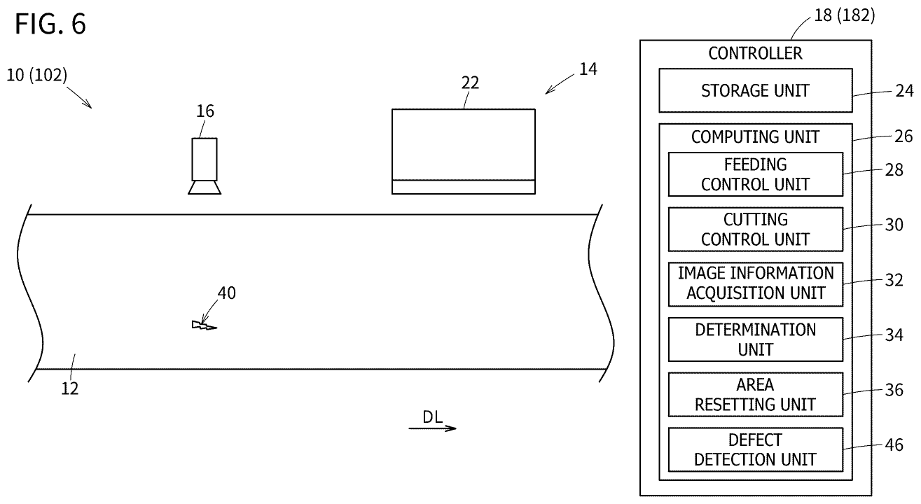

FIG. 6 is a configuration diagram of the punching system 10 (punching system 102) according to a second modified example.

The punching system 102 described below includes the punching device 14, the imaging device 16, and a controller 18 (controller 182) according to this modified example. The controller 182 at least differs from the controller 18 of one embodiment in that it further includes a defect detection unit 46. The defect detection unit 46 is realized by the processing circuitry of the computing unit 26, as in the case of the feeding control unit 28 and the like.

The defect detection unit 46 detects the defective site 40 included in the sheet base material 12, based on the image information acquired from the imaging device 16 by the image information acquisition unit 32. In this case, the image information acquisition unit 32 may acquire the image information from a plurality of imaging devices 16 including an imaging device 16 that images the front surface of the sheet base material 12 and an imaging device 16 that images the back surface of the sheet base material 12.

The determination unit 34 performs the presence/absence determination based on the detection result of the defective site 40 from the defect detection unit 46. According to this modified example, the area reset unit 36 can execute the area reset process even when the mark 42 (see one embodiment or the first modification) indicating the position of the defective site 40 is not on the sheet base material 12.

With respect to the above embodiments, the following supplementary notes are further disclosed.

### Supplementary Note 1

A controller (18) for a punching device (14) configured to sequentially punch a long sheet base material (12) into a predetermined shape while feeding the sheet base material in the longitudinal direction (DL) of the sheet base material, wherein a plurality of reserved-for-punching areas (38) that are to be punched by the punching device are set in advance on the sheet base material so as to be arranged in the longitudinal direction at a predetermined interval (G), the controller comprising: an image information acquisition unit (32) configured to acquire image information on the sheet base material from an imaging device (16) configured to image the sheet base material; a determination unit (34) configured to determine, based on the image information, whether a specific reserved-for-punching area (38S) is present, which is a reserved-for-punching area that overlaps at least one defective site (40) included in the sheet base material; and an area resetting unit (36) configured to shift, in a case where the specific reserved-for-punching area is present, the reserved-for-punching area determined to be the specific reserved-for-punching area upstream in the feed path for the sheet base material with respect to the defective site. This allows the controller to produce a good quality product that does not contain defective sites while reducing the unused area of the sheet base material.

### Supplementary Note 2

In the controller according to supplementary note 1, in a case where the specific reserved-for-punching area is present, the area resetting unit may reset the reserved-for-punching area determined to be the specific reserved-for-punching area to a position separated from the defective site by the predetermined interval.

### Supplementary Note 3

In the control device according to supplementary note 2, in a case where the reserved-for-punching area determined to be the specific reserved-for-punching area because the reserved-for-punching area overlaps a first defective site, which is one of the defective site, is reset to a position upstream in the feeding path with respect to the first defective site, and overlaps a second defective site, which is another one of the defective site, the area resetting unit may reset the reserved-for-punching area overlapping the second defective site to a position upstream in the feeding path with respect to the second defective site. This allows the controller to produce a good quality product that does not contain defective sites while reducing the unused area of the sheet base material.

### Supplementary Note 4

In the control device according to supplementary note 2, the predetermined interval may be shorter than a dimension (L38) in the longitudinal direction of each of the plurality of reserved-for-punching areas. This suppresses the increase in the unused area on the sheet base material.

### Supplementary Note 5

In the controller according to any one of supplementary notes 1 to 4, the mark (42) indicating the position of the defective site may be applied to the sheet base material in advance before imaging by the imaging device, and the determination unit may determine whether the specific reserved-for-punching area is present, based on the position of the mark indicated by the image information. Thus, the determination unit can preferably identify the position of the defective site based on the image information.

### Supplementary Note 6

In the controller according to any one of supplementary notes 1 to 4, the area resetting unit may shift, according to the amount of shifting of the reserved-for-punching area determined to be the specific reserved-for-punching area upstream in the feeding path, all the reserved-for-punching areas located in the feeding path upstream of the reserved-for-punching area determined to be the specific reserved-for-punching area. This prevents the position of a reserved-for-punching area determined to be the specific reserved-for-punching area from overlapping the positions of other reserved-for-punching areas located upstream of the reserved-for-punching area.

### Supplementary Note 7

A method for controlling a punching device (14) configured to sequentially punch a long sheet base material (12) into a predetermined shape while feeding the sheet base material in the longitudinal direction (DL) of the sheet base material, wherein a plurality of reserved-for-punching areas (38) that are to be punched by the punching device are set in advance on the sheet base material so as to be arranged in the longitudinal direction at a predetermined interval (G), the method comprising: an image information acquisition step (S2) of acquiring image information on the sheet base material from an imaging device (16) configured to image the sheet base material; a determination step (S3) of determining, based on the image information, whether a specific reserved-for-punching area (38S) is present, which is a reserved-for-punching area that overlaps at least one defective site (40) included in the sheet base material; and an area resetting step (S4) of shifting, in a case where the specific reserved-for-punching area is present, the reserved-for-punching area determined to be the specific reserved-for-punching area upstream in the feed path for the sheet base material with respect to the defective site.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A controller for a punching device configured to sequentially punch a long sheet base material into a predetermined shape while feeding the sheet base material in a longitudinal direction of the sheet base material,
wherein a plurality of reserved-for-punching areas that are to be punched by the punching device are set in advance on the sheet base material so as to be arranged in the longitudinal direction at a predetermined interval,
the controller comprising one or more processors, wherein the one or more processors execute computer-executable instructions stored in a memory to cause the controller to:
acquire image information on the sheet base material from an imaging device configured to image the sheet base material;
determine, based on the image information, whether a specific reserved-for-punching area is present, which is a reserved-for-punching area that overlaps at least one defective site included in the sheet base material; and
in a case where the specific reserved-for-punching area is present, shift the reserved-for-punching area determined to be the specific reserved-for-punching area upstream in a feeding path for the sheet base material with respect to the defective site.

2. The controller according to claim 1, wherein
the one or more processors cause the controller to, in the case where the specific reserved-for-punching area is present, reset the reserved-for-punching area determined to be the specific reserved-for-punching area to a position separated from the defective site by the predetermined interval.

3. The controller according to claim 2, wherein
the one or more processors cause the controller to, in a case where the reserved-for-punching area determined to be the specific reserved-for-punching area because of the reserved-for-punching area overlapping a first defective site, which is one of the defective site, is reset to a position upstream in the feeding path with respect to the first defective site, and overlaps a second defective site, which is another one of the defective site, reset the reserved-for-punching area overlapping the second defective site to a position upstream in the feeding path with respect to the second defective site.

4. The controller according to claim 2, wherein
the predetermined interval is shorter than a dimension in the longitudinal direction of each of the plurality of reserved-for-punching areas.

5. The controller according to claim 1, wherein
a mark indicating a position of the defective site is applied to the sheet base material in advance before imaging by the imaging device, and
the one or more processors execute the computer-executable instructions to cause the controller to determine whether the specific reserved-for-punching area is present, based on a position of the mark indicated by the image information.

6. The controller according to claim 1, wherein
the one or more processors cause the controller to shift, according to an amount of shifting of the reserved-for-punching area determined to be the specific reserved-for-punching area upstream in the feeding path, all the reserved-for-punching areas located in the feeding path upstream of the reserved-for-punching area determined to be the specific reserved-for-punching area.

7. A method for controlling a punching device configured to sequentially punch a long sheet base material into a predetermined shape while feeding the sheet base material in a longitudinal direction of the sheet base material, wherein the method is executed by one or more processors,
wherein a plurality of reserved-for-punching areas that are to be punched by the punching device are set in advance on the sheet base material so as to be arranged in the longitudinal direction at predetermined intervals,
the method comprising:
acquiring image information on the sheet base material from an imaging device configured to image the sheet base material;
determining, based on the image information, whether a specific reserved-for-punching area is present, which is a reserved-for-punching area that overlaps a defective site included in the sheet base material; and
in a case where the specific reserved-for-punching area is present, shifting the reserved-for-punching area determined to be the specific reserved-for-punching area upstream in a feeding path for the sheet base material with respect to the defective site.
